(19) United States
(12) Patent Application Publication
(10) Pub. No.: US 2012/0132736 A1
(43) Pub. Date: May 31, 2012

(54) Silicon metal grinding machine

(76) Inventor: Xinqi Zhu, Yang Zhou City (CN)

(21) Appl. No.: 13/200,050

(22) Filed: Sep. 19, 2011

(30) Foreign Application Priority Data
Nov. 29, 2010 (CN) 201020630329.3

(51) Int. Cl. B02C 19/00

(52) U.S. Cl. 241/30; 241/277

(57) ABSTRACT

A pulverizing grinder used in the industrial processing of partially processed, or raw, silicon ore to achieve finely powdered silicon or silicon compound. It involves several parts, primarily an electric motor and a disc and blade arrangement driven by the motor, to achieve a finely ground silicon powder material. The upper part of case contains the electric motor, which dives a shaft that extends to a lower part of the case. The revolving shaft of electric motor is connected with the main shaft inside the case. At least one tier of rotating disc is fastened to the bottom of the shaft. Each disc has an even number of blades, each of which is positioned by suitable anchor fixture. The grinding or pulverizing of the silicon material is achieved by the high speed rotation of the discs and the impact of the blades on the material. This machine is particularly adapted to the processing requirements of metallic silicon, and is capable of producing particles of different diameters with a high degree of efficiency, reliability and ease of operation.

### BACKGROUND OF THE INVENTION

Embodiments of the invention relate to the field of processing silicon ore, and silicon or silica containing material in unprocessed or partially processed forms. More particularly, embodiments of the invention relate to the material grinding, crushing and milling process that results in the production of metallurgical grade silicon from coarser silicon bearing materials.

The terms used in this specification generally have their ordinary meanings in the art, within the context of the disclosure, and in the specific context where each term is used. The disclosure is not limited to the any specific embodiment given in this specification, as the size and number of rotating discs and blades, as well as the motor parameters may be varied as necessary to meet production requirements. As used herein, the terms “comprising,” “including,” “having,” “containing,” “involving,” and the like are to understood to be open-ended, i.e., to mean including but not limited to.

### BRIEF SUMMARY OF THE INVENTION

This new grinder design is intended to be applied in the industrial processing silicon ore, or partially processed bulk silicon material. The processing provided by the grinder design is intended to supply a high quality, finely ground silicon that is suitable for use in the next processing steps leading to the processor and memory “chips” used in all electronic components.

The principal design advantage of the silicon metal grinding machine, compared to existing machines having the same function, is that the end product, finely powdered silicon, is delivered with a particle size (diameter) distribution that is readily usable, without the necessity of additional grinding or pulverizing processes. The range of available machines that are used to obtain silica powder from ore materials—including roller-crushing mills, plate, ball and rod mills, pan grinders, and the Raymond mill—do not produce silica in readily usable powder particle diameters. The main reason is that these kinds of crush/grind machines do not use rotators or attritors that are designed and engineered to produce silicon powder. Instead, they are converted to silica powder production from other primary uses. Because its design is optimized for raw silicon, the silicon metal grinding machine succeeds in producing immediately usable silica powders. Consequently, it provides a highly efficient grinder for processing metallurgical grade silicon.

For better grinding effectiveness, the rotator is constructed from high-chromium iron or high-chromium steel, and the exterior of the rotator is coated with tungsten, tungsten carbide or titanium.

In addition, the (rotating) discs can be replaced and the number of discs and blades varied as required to achieve the desired diameters for particles. The more rotating discs used, the thinner, or finer, the powder becomes. Conversely, the fewer discs or blades used, the coarser the powder becomes. At the same time, the rotational speed of the electric motor can be varied during the grinding process as an additional control on achieving the desired particle size (diameter).

Taken together, the elements of the design of the silicon metal grinding machine provides for a high degree of efficiency, reliability and ease of operation.

### BRIEF DESCRIPTION OF THE DRAWING

The single FIGURE drawing is a cross-sectional view of the silicon metal grinding machine according to this invention.

### DETAILED DESCRIPTION OF THE INVENTION

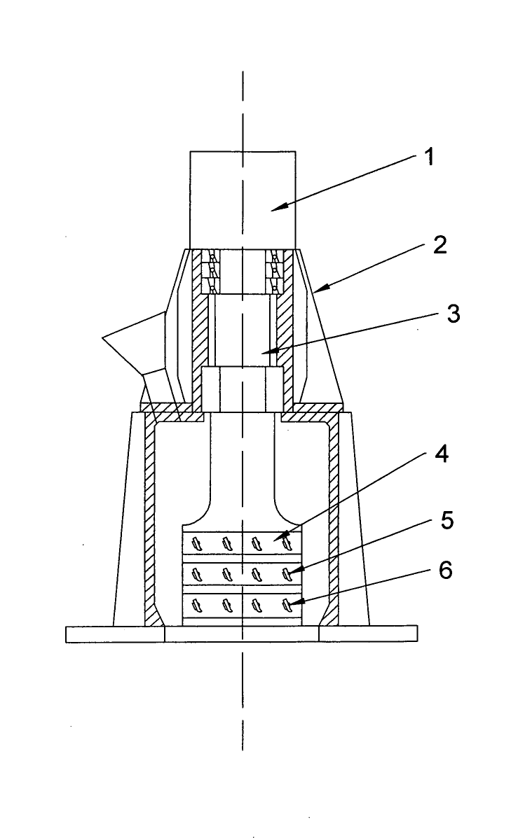

As shown in FIG. 1, the silicon metal grinding machine incorporates a case (2), which holds, contains and supports the entire apparatus. An electric motor (1) is provided in the upper section of the case (2). The shaft of the electric motor is connected to, and drives, the principal, or main, shaft (3) inside the middle and lower section of case (2). One, or more, tiers of revolving discs (4) are fastened to the principal shaft (3) in the lower section of the case (2). The grinding or pulverization of the silicon bearing material occurs in this section of the case (2).

Three tiers are shown as an aid to visualizing the grinding and pulverizing action that occurs within the lower section of the case. Each tier of revolving discs is affixed with several blades (6), evenly spaced around the disc, each having a through hole in the center to facilitate material flow around, and through, the blade. The blades (6) are connected to the revolving discs (4) by an anchoring fixture (5). The rotator blades (6) are constructed of high-chromium iron or high-chromium steel. The principal shaft (3) consists of three sections of different geometries that bolt together to facilitate maintenance and repair, but are herein referred to as one piece of the apparatus.

The exterior of the principal or main shaft (3) may be coated or electroplated with tungsten, tungsten carbide or titanium.

1. An apparatus by which bulk or partly processed silicon ore or silicon/metal mixtures are processed to achieve a fine, high quality silica powder using a proprietary motor driven disc and blade grinding system.

2. A method according to claim 1 that incorporates one, or more, rotating discs constructed of high-chromium iron or high-chromium steel.

3. A method according to claim 2 in which more than one rotating disc may be stacked on the principal shaft within the lower grinding section of the case.

4. A method according to claim 2 in which the rotating discs are coated or electroplated with tungsten, tungsten carbide or titanium.

5. A method according to claim 2 in which two or more blades are attached to the rotating discs to provide grinding, pulverizing or milling, of the silicon, or silicon ore, material.

6. A method according to claim 5 in which the blade is attached to the rotating disc by means of an anchoring fixture.

7. A method according to claim 5 in which the blade incorporates a central hole to allow for material flow through the blade.

8. A silicon metal grinding machine involving several parts with in a case, the upper part of the case fitted with an electric motor, the revolving shaft of the electric motor connected to a principal, or main, shaft inside the case, at least one tier of rotating discs fastened to the bottom of the principal shaft, each tier of revolving discs fastened to at least two rotator blades having a through hole in the center and the blades being attached to the rotator disc by a bolted fixture.

9. A machine described in claim 8 wherein by the material for the rotator is high-chromium iron or high-chromium steel.

10. A machine according to claim 8 wherein the exterior of the rotating disc is coated with tungsten, tungsten carbide or titanium.
